(19) United States
(12) Patent Application Publication
(10) Pub. No.: US 2007/0164484 A1
(43) Pub. Date: Jul. 19, 2007

(54) Method of manufacturing molded products having surface designs

(76) Inventor: Francis Piccolo, Natchitoches, LA (US)

Correspondence Address: Ted M. Anthony, Suite 1600, 600 Jefferson Street, Lafayette, LA, 70501, US

(21) Appl. No.: 11/592,343

(22) Filed: Nov. 3, 2006

Related U.S. Application Data
(60) Provisional application No. 60/758,942, filed on Jan. 13, 2006.

(51) Int. Cl. B28B 3/00

(52) U.S. Cl. 264/333

(57) ABSTRACT

A method of manufacturing molded concrete products including, but not limited to, precast concrete panels having at least one decorative design on the surface(s) of such panels. At least one chemical cement retarder to a substrate. Thereafter, a stencil pattern embodying a desired pattern is placed on the retarder-laden substrate and secured in place. The substrate with the affixed stencil is then placed in a casting bed and secured from movement within such casting bed. Concrete mixed to desired specifications is poured or otherwise introduced into the casting bed. If colored panels are desired, colored aggregates can be added to the concrete by replacing portions of certain fine aggregates normally found in concrete with colored aggregates. The concrete in the casting bed is allowed to harden, thereby forming a concrete panel in the casting bed. The concrete panel is lifted from the casting bed and the retarder-laden substrate is then removed from the panel. The mortar from the area of the panel contacting the retarder can be selectively washed away from the concrete panel. Although such washing can be performed using any number of different methods, in the preferred embodiment such mortar is washed away using a water hose or pressure washer.

### CROSS REFERENCES TO RELATED APPLICATIONS

This Application relates to Provisional Patent Application filed Jan. 13, 2006, having Application Ser. No. 60/758,942.

### STATEMENTS AS TO RIGHTS TO INVENTIONS MADE UNDER FEDERALLY SPONSORED RESEARCH AND DEVELOPMENT

NONE

### BACKGROUND OF THE INVENTION

1. Field of the Invention

The present invention pertains to a method for creating molded products, such as concrete panels and the like, having at least one pattern on at least one surface. More particularly, the present invention pertains to a method for forming concrete panels having the appearance of hand laid veneer brick on at least one surface.

2. Brief Description of the Prior Art

The surfaces of certain concrete products and various buildings are frequently prepared and/or decorated by means of washing (“washing finish”) technology. Such technology typically involves washing one or more surfaces of a concrete product with water or other liquid prior to the complete hardening of such concrete, so that the mortar on the surface of the product can be washed away, thereby exposing aggregates (mixed within the concrete) on the surface of the product. Generally, the washing operation must be performed during a strictly limited time window, because the success of the washing operation is closely linked to the hardening rate of the concrete. Once the concrete reaches a sufficient hardness, the mortar will not be removed and the washing operation will not yield satisfactory results.

Molded concrete products, including products manufactured using precast technology, are currently in common use. Such precast concrete products can include, but are not necessarily limited to, wall panels in buildings and other structures, and concrete slabs utilized for pavement decoration. Frequently, surfaces of such molded precast concrete products are decorated using a washing finish technology described above. In such instances, the washing finish technology is typically used to impart a desired pattern on a surface of such products. Surface patterns can include, but are not necessarily limited to, patterns resembling hand laid veneer brick or other similar designs.

During the manufacture of such molded concrete products, it is frequently difficult to beneficially coordinate the washing operation with the hardening of the concrete product. Put another way, it is difficult to ensure that the washing operation occurs when the concrete of the product is at its optimal hardness. To the extent possible, it is advantageous for the washing of the concrete product to be performed significantly after the casting of such product, to permit handling and/or physical manipulation of said product. However, the concrete should not be so hard that mortar cannot be effectively washed from the desired surface(s) of such product.

It is well known to apply a cement-hardening retarder, which is a kind of a cement admixture (cement additive), to the surface of concrete products, including molded concrete products. The cement-hardening retarder acts to delay the hardening rate of the concrete along the surface of the product exposed to such retarder. By slowing the hardening rate of the surface layer of a concrete product, the mortar content of the concrete surface layer can be washed away to expose the underlying aggregate, regardless of the hardening rate of the remainder of the concrete product.

Use of cement-hardening retarders are well known in connection with the manufacture of precast concrete panels. For example, it is known in the prior art to coat the inner surface of a concrete mold with an aqueous solution containing at least one conventional cement retarding agent and a thickener. Thereafter, wet concrete is deposited in the mold. The concrete is allowed to harden, the hardened product is removed from the mold, and the surface of the product (which was exposed to the retarder solution) is washed with water or other pressurized liquid. Unfortunately, this process can be time consuming, messy and can frequently yield imprecise results. Moreover, this prior art method does not permit manufacture of panels having uniform patterns along one or more surfaces of such products.

Attempts have been made to impregnate a substrate (such as paper or the like) with conventional cement retarders. However, existing methods of manufacturing concrete panels using substrate(s) impregnated with cement retarder(s) do not generate aesthetically pleasing surface designs. As such, current methods of using chemical cement retarders to impart patterns on precast concrete products are clearly functionally and economically inferior to the method of the present invention.

Thus, there is a need for an improved method for forming concrete products including, but not necessarily limited to, precast concrete panels, having decorative designs on at least one surface. Such surface designs should be easy to produce (and reproduce) with a minimum of expense and mess. Further, such designs should be aesthetically pleasing and, if desired, accurately simulate desired patterns such as, for example, hand laid veneer brick.

### SUMMARY OF THE PRESENT INVENTION

The present invention permits the manufacture of molded concrete products, such as, for example precast concrete panels, having at least one decorative design on the surface(s) of said concrete panels. Although the panels can be used in any number of different applications, such panels can be beneficially used in both the “architectural precast” and the “tilt-up” concrete industries.

The method of the present invention generally comprises applying at least one chemical cement retarder to a substrate. In the preferred embodiment, said substrate is paper; however, it is to be observed that other carriers for such chemical cement retarder(s) may be used to generate similar beneficial results. If the cement retarder is applied to said substrate in a liquid form, it is generally beneficial to permit such cement retarder to dry on the subject substrate.

Thereafter, a stencil pattern embodying a desired pattern is placed on the retarder-laden substrate and secured in place. Although any number or types and/or configurations of stencil can be used, in the preferred embodiment, said stencil has a thickness; as such, in the preferred embodiment, said stencil is raised and/or extends above said substrate.

The substrate with the affixed stencil is then placed in a casting bed. Concrete casting beds are well known in the art, and the size and geometry of said casting bed should ideally correspond to the desired shape and geometry of a concrete product to be formed. The retarder-laden substrate with affixed stencil is secured from movement within such casting bed, ideally using an adhesive such as, for example, double-sided tape. If necessary, successive or alternating sections of retarder-laden substrate (including attached stencils) can be placed in said casting bed to generate desired pattern(s) on the outer surface(s) of the precast panel to be manufactured.

Thereafter, concrete mixed to desired specifications is poured or otherwise introduced into the casting bed. If reinforced concrete panels are desired, reinforcing members can be placed in such casting bed in a manner well known to those having skill in the art prior to introduction of such concrete into the casting bed. Similarly, if colored panels are desired, colored aggregates can also be optionally added to the concrete by replacing portions of certain fine aggregates normally found in concrete with colored aggregates. In the preferred embodiment, said concrete covers the retarder-laden substrate and accompanying stencil previously laid out in said casting bed.

The concrete in the casting bed is allowed to harden, thereby forming a concrete panel in said casting bed. The concrete panel is allowed to harden until said panel can be lifted from said bed. Generally, said panel is lifted from the bed utilizing methods which are well known to those having skill in the art of precast molding. When the panel is lifted, the retarder-laden substrate and accompanying stencil cling or bond to the bottom side of said concrete panel.

After the concrete panel has been removed from the casting bed, the retarder-laden substrate is then removed from the bottom face of such panel. Throughout the casting process, chemical cement retarder(s) from the substrate transfer to the concrete on the adjacent surface of said panel. However, the stencil acts as a mask to prevent such transfer of cement retarder(s) from portions of said substrate to the panel. As such, the chemical cement retarder(s) are only transferred to areas of the concrete not masked by the stencil.

Cement retarder(s) transferred from the substrate to the concrete panel prevent the concrete from fully hardening in areas of the panel coming in contact with the concrete. The mortar from such retarded area can be selectively washed away from the applicable surface of said concrete panel. Although such washing can be performed using any number of different methods, in the preferred embodiment such mortar is washed away using a water hose or pressure washer. Following such washing, the surface of the concrete panel around said stencil is generally different in is texture from the concrete existing under such stencil. Further, to the extent that colored aggregate is included in the concrete, such washing also serves to expose such aggregate.

When the stencil is removed, the areas previously covered by said stencil have the appearance of a mortar joint or other pattern on the surface of the panel. When a stencil having a thickness is used, the areas covered by said stencil form an indentation or recess on the surface of the concrete panel. Because the stencil creates a pattern on the surface of the panel, the finished concrete panel reflects the desired appearance. Although any number of different patterns and/or designs can be utilized, the method of the present invention is particularly beneficial for formation of concrete panels having the appearance of hand laid veneer brick. In such cases, colored aggregate approximating the color of brick is included in the concrete mixture and exposed as set forth above. However, it is to be observed that the method of the present invention can be used to generate molded products having any number of different surface designs and/or configurations.

If desired, a similar process can be applied to other surfaces of the precast concrete panel. In this manner, a pattern can be imparted to the upper surface of such panel. Although any pattern can be used, in many applications it is desirable for the pattern/appearance of the upper surface of the panel to match the bottom surface of the concrete panel.

### BRIEF DESCRIPTION OF THE DRAWINGS

FIG. 1 depicts a schematic view of cement retarding agent being applied to a substrate.

FIG. 2 depicts a schematic view of a stencil being applied to a retarder-laden substrate.

FIG. 2a depicts a cross-sectional view of the stencil of FIG. 2 taken along line 2-2

FIG. 3 depicts a schematic view of a retarder-laden substrate and stencil being loaded within a casting bed.

FIG. 4 depicts a schematic view of wet concrete being introduced into a casting bed.

FIG. 5 depicts a schematic view of forms being removed from a casting bed.

FIG. 6 depicts a schematic view of a molded concrete panel being suspended after being lifted from a casting bed.

FIG. 7 depicts washing of at least one surface of a suspended concrete panel.

### DETAILED DESCRIPTION OF A PREFERRED EMBODIMENT

The present invention is a method for manufacturing molded products, such as, for example, precast concrete panels having decorative designs on one or more surfaces of said concrete panels.

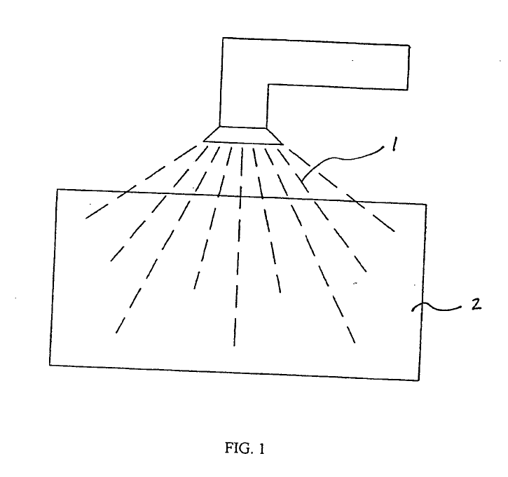

Referring to the drawings, FIG. 1 depicts a schematic view of at least one cement retarder 1 being applied to substrate 2. Such cement retarder 1 can be any number of commercially available cement retarding agents well known in the art (for example, CSE® Nova brand by Hebau, EXPOSE IT!™ brand Form Retarder from Fister, Inc.) or combinations thereof. In the preferred embodiment, substrate 2 is made of paper; however, it is to be observed that other carriers for such cement retarder(s) may be used to generate similar beneficial results. Also, in the preferred embodiment, cement retarder 1 is applied to substrate 2 in a liquid form. As such, it is generally beneficial to evenly spread cement retarder 1 along the entire surface of substrate 2, and to permit cement retarder 1 to dry on substrate 2.

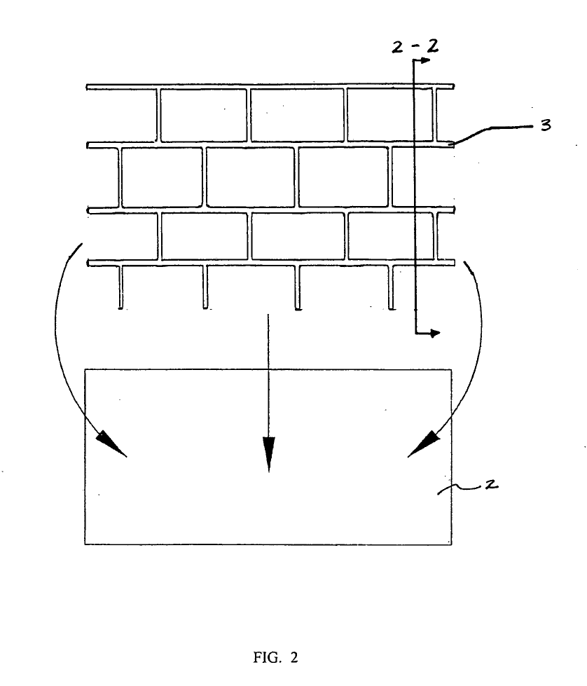

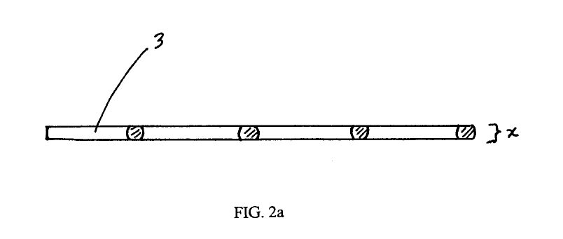

Referring to FIG. 2, stencil 3 having a desired pattern, is placed on the retarder-laden substrate 2. Stencil 3 is depicted in FIG. 2 as having a configuration of offset rectangles approximating the mortar joints of a brick structure. However, it is to be observed that any number of different stencil configurations can be used to generate a desired pattern or design. Moreover, in the preferred embodiment, stencil 3 has a thickness; as such, stencil 3 will be raised or extend above said substrate.

FIG. 2a depicts a cross-sectional view of stencil 3 taken along line 2-2. As set forth above, stencil 3 can have any number of different thicknesses. In the present example, stencil 3 is intended to approximate mortar joints observed in a brick structure. Thus, the thickness of stencil 3—shown as dimension “x” in FIG. 2a, should be roughly equivalent to the depth of a mortar joint in a brick structure having a desired appearance. In many instances, this thickness will be at least 0.125 inches.

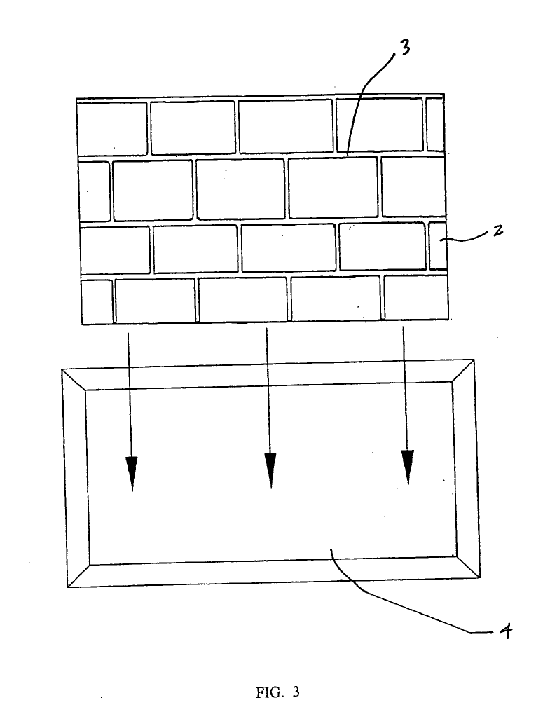

Referring to FIG. 3, substrate 2 with affixed stencil 3 is then placed in casting bed 4. Concrete casting beds, such as concrete casting bed 4, are well known in the art. The size and geometry of casting bed 4 should ideally correspond to the desired size and geometry of a concrete panel to be formed according to the method of the present invention. Cement retarder-laden substrate 2 with affixed stencil 3 is secured from movement within casting bed 4. If necessary, successive or alternating sections of cement retarder-laden substrate (including attached stencils) are placed in casting bed 4 to generate desired pattern(s) on the outer surface(s) of the concrete panel to be manufactured.

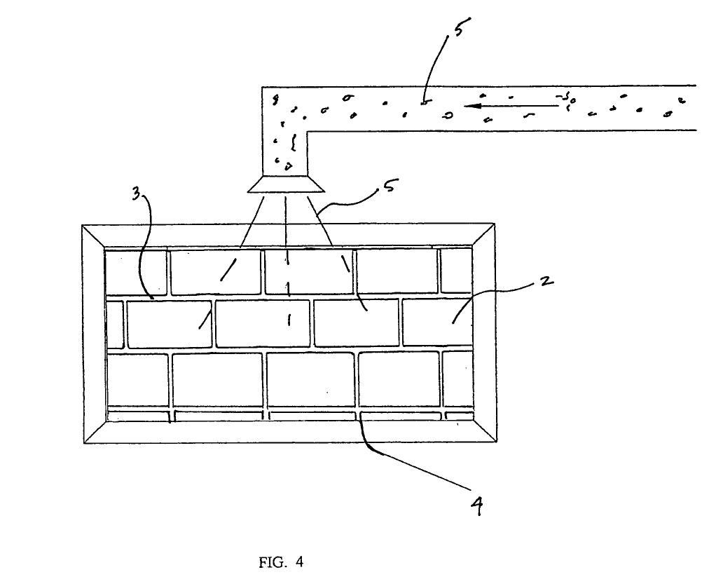

Referring to FIG. 4, concrete mixture 5 mixed to desired specifications is poured or otherwise introduced into casting bed 4. If reinforced concrete panels are desired, reinforcing members can be placed in such casting bed in a manner well known to those having skill in the art before concrete mixture 5 is introduced into casting bed 4. Similarly, if colored concrete panels are desired, colored aggregate(s) can also be optionally added to the concrete by replacing portions of certain fine aggregates normally found in concrete with colored aggregates in a manner well known to those having skill in the art. In the preferred embodiment, concrete mixture 5 covers cement retarder-laden substrate 2 and accompanying stencil 3 that were previously laid out within casting bed 4.

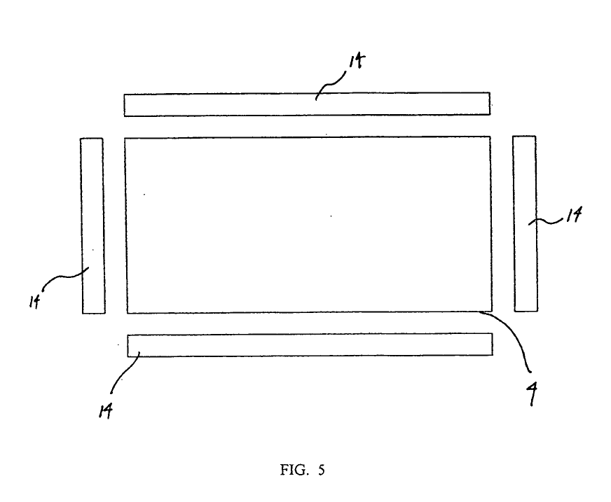

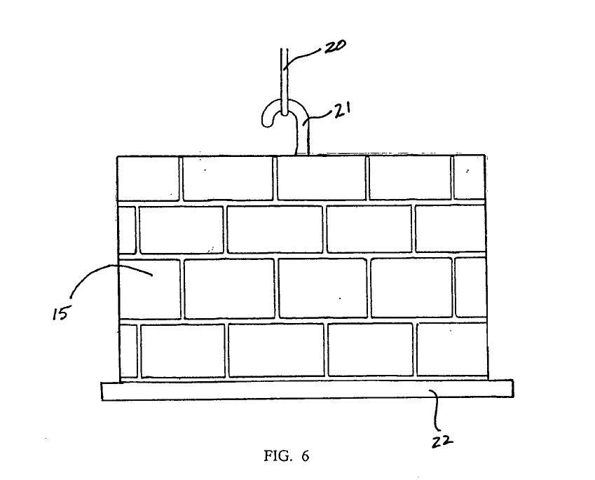

Concrete mixture 5 in casting bed 4 is allowed to harden and at least partially solidify, thereby resulting in concrete panel 15 forming within casting bed 4. Concrete panel 15 is allowed to harden until panel 15 can be lifted from casting bed 4. Referring to FIG. 5, forms 14 are removed from casting bed 4. Referring to FIG. 6, panel 15 is lifted from casting bed 4 utilizing any number of different methods which are well known to those having skill in the art of precast molding. By way of example, but not limitation, concrete panel 15 can be lifted using lifting bracket 22, hook 21 and hoist line 20. When panel 15 is lifted, cement retarder-laden substrate 2 and accompanying stencil 3 will frequently bond to the surface of said concrete panel 15 that faced downward within casting bed 4. (For purposes of this discussion, such surface will be referred to as the “bottom” of panel 15.) Once panel 15 is lifted, substrate 2 and stencil 3 must be removed from said panel.

Throughout the casting process, chemical cement retarder(s) from substrate 2 transfer to the concrete on the adjacent surface of panel 15. However, stencil 3 acts as a mask to prevent such transfer of cement retarder(s) from corresponding portions of substrate 2 to panel 15. As such, the chemical cement retarder(s) on substrate 2 are only transferred to areas of the concrete of concrete panel 15 not masked by the stencil.

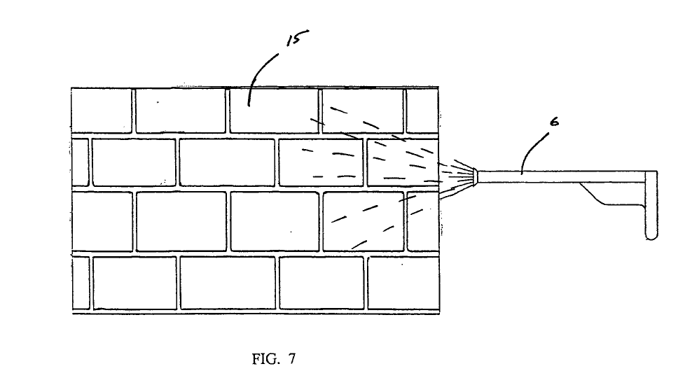

Chemical cement retarder(s) transferred from substrate 2 to concrete panel 15 prevent such concrete from fully hardening in areas of panel 15 other than those covered by stencil 3. Referring to FIG. 7, mortar from areas of panel 15 can be selectively washed away from the applicable surface(s) of concrete panel 15. Although such washing can be performed using any number of different methods, in the preferred embodiment such mortar is washed away using water sprayed via pressure washer 6. Following such washing, the surface of concrete panel 15 around said stencil is generally different in texture from concrete existing under stencil 3. Further, to the extent that colored aggregate is included in concrete, such washing with pressure washer 6 also serves to expose such aggregate.

When stencil 3 is removed, the portions of panel 15 previously covered by said stencil have the appearance of a mortar joint or other break in the pattern of the panel. When a stencil, such as stencil 3, having a substantial thickness is used, the areas of panel 15 that were exposed to cement retarder-laden substrate 2 covered by stencil 3 form an indentation or recess in the surface of concrete panel 15. Because stencil 3 creates a pattern in the surface of panel 15, the finished concrete panel reflects such pattern and the desired appearance. Although any number of different patterns and/or designs can be utilized, the method of the present invention is particularly beneficial for formation of concrete panels having the appearance of hand laid veneer brick. In such cases, colored aggregate approximating the color of brick and included in the concrete mixture and exposed as set forth above.

If desired, a similar process can be applied to the upper surface of a precast concrete panel, such as panel 15. In this manner, a desired pattern can be imparted to the upper surface of such panel. Although any pattern can be used, in many applications it is desirable for the pattern/appearance of the upper surface of the panel to match the bottom surface of the concrete panel.

The above-described invention has a number of particular features which should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

What is claimed:

1. A method of manufacturing molded concrete products comprising:
a. securing a stencil to a substrate having at least one cement retarder disposed thereon;
b. placing said substrate and stencil in a casting bed;
c. introducing a concrete mixture in said casting bed, wherein said concrete mixture at least partially covers said substrate and stencil;
d. allowing said concrete mixture to solidify;
e. extracting said solidified concrete from said bed; and
f. removing mortar from areas of said concrete exposed to said at least one cement retarder.

2. The method of claim 1, wherein mortar is removed from areas of said concrete exposed to said at least one cement retarder by washing said concrete with pressurized fluid.

3. The method of claim 1, wherein said substrate is paper.

4. The method of claim 1, wherein said concrete mixture includes colored aggregates.

5. The method of claim 1, wherein said stencil has a thickness of at least 0.125 inches.

6. The method of claim 1, wherein said stencil has an adhesive backing.

7. A method of manufacturing molded concrete products comprising:
a. applying at least one cement retarder to a substrate;
b. securing a stencil to said substrate;
c. placing said substrate and stencil in a casting bed;
d. placing at least one reinforcing member in said casting bed;
e. introducing a concrete mixture in said casting bed, wherein said concrete mixture at least partially covers said substrate and stencil;
f. allowing said concrete mixture to solidify;
g. extracting said solidified concrete from said bed; and
h. removing mortar from areas of said concrete exposed to said at least one cement retarder.

8. The method of claim 7, wherein mortar is removed from areas of said concrete exposed to said at least one cement retarder by washing said concrete with pressurized fluid.

9. The method of claim 7, wherein said substrate is paper.

10. The method of claim 7, wherein said concrete mixture includes colored aggregates.

11. The method of claim 7, wherein said stencil has a thickness of at least 0.125 inches.

12. The method of claim 7, wherein said stencil has an adhesive backing.
